(19) United States
(12) Patent Application Publication
(10) Pub. No.: US 2011/0233276 A1
(43) Pub. Date: Sep. 29, 2011

(54) READING UNIT FOR READING INFORMATION OF CARDS

(76) Inventor: JÜRGEN BUCHERT, Schweinfurt (DE)

(21) Appl. No.: 12/850,207

(22) Filed: Aug. 4, 2010

(30) Foreign Application Priority Data
Aug. 4, 2009 (DE) DE102009036008.5

(51) Int. Cl. G06K 7/01

(52) U.S. Cl. 235/439

(57) ABSTRACT

A reading unit includes an entry slot for receiving a card and an exit slot for dispensing the card. Arranged between the entry slot and the exit slot is a reader for reading information on the card. A disinfector to disinfect the card is arranged in the interior of the reading unit as the card enters into the entry slot and/or as the card is discharged from the exit slot. As a result, a user of the card is protected against risk of infection.

### CROSS-REFERENCES TO RELATED APPLICATIONS

This application claims the priority of German Patent Application, Serial No. 10 2009 036 008.5, filed Aug. 4, 2009, pursuant to 35 U.S.C. 119(a)-(d), the content of which is incorporated herein by reference in its entirety as if fully set forth herein.

### BACKGROUND OF THE INVENTION

The present invention relates, in general, to a reading unit for reading information contained on a card.

The following discussion of related art is provided to assist the reader in understanding the advantages of the invention, and is not to be construed as an admission that this related art is prior art to this invention.

Cards, typically made of plastic, e.g. credit cards from large credit companies or credit cards or cards for acquiring reward points from department stores or other stores, are increasingly issued. Even airline companies issue cards to passengers to acquire reward points or to book flights.

A problem associated with cards is the risk of infection that is caused by the cards. When being used in a machine or equipment, bacteria, viruses, and germs may be transmitted by these cards to the machine or passed on by the machine. This danger progressively increases as a result of globalization of commercial actions. Thus, when, for example, inserting a credit card into a reading unit for booking purposes, there is no assurance of avoiding infection of the credit card by the reading unit itself, when the latter has been infected by a previously inserted credit card. Moreover, there is no assurance that the user who inserted the credit card into the reading unit, e.g. reception personnel in a hotel, does not infect the credit card by herself or himself.

This problem may conceivably be avoided when the card owner without assistance of a further person inserts the card by herself or himself and withdraws it again. Still, there is the possibility of infection of the card by the reading unit itself.

It would therefore be desirable and advantageous to provide an improved reading unit to obviate prior art shortcomings and to prevent infection of a card when being read by the reading unit to thereby protect the user.

### SUMMARY OF THE INVENTION

According to one aspect of the present invention, a reading unit includes an entry slot for receiving a card, an exit slot for dispensing the card, a reader arranged between the entry slot and the exit slot for reading information on the card, and a disinfector disinfecting the card at least in one of the phases selected from the group consisting of during entry of the card into the entry slot and during discharge of the card from the exit slot.

The present invention is thus able to resolve prior art problems by providing the reading unit with a disinfector at a suitable location.

This disinfector ensures that the reading unit is disinfected after a card has been released after being read or printed and that no viruses, bacteria and germs can be passed on by the card. In addition, it is ensured that the user of the card is protected against risk of infection, even when another person has inserted the card into the reading unit.

According to another advantageous feature of the present invention, the disinfector may be arranged in close proximity of the entry slot or in close proximity of the exit slot, or two disinfectors may be arranged in close proximity of the entry and ext slots, respectively. As a result, the entire card can be disinfected during insertion and during discharge. This is also true, when the entry slot at the same time is also provided as the exit slot.

Suitably, the disinfector acts on both sides of the card.

According to another advantageous feature of the present invention, the disinfector may include a light source for radiating UV light into a direction of the card. The disinfector may hereby include two UV light tubes arranged in parallel relation behind the entry slot to define a passageway through which the card is able to travel. Instead of UV light, infrared light may also be used in certain cases.

According to another advantageous feature of the present invention, the disinfector can be constructed to release a disinfectant onto the card. The disinfector may hereby include a storage container and a sponge operably connected with the storage container for repeated moisturizing of the sponge with disinfectant. Advantageously, the disinfector includes two sponges in parallel relation to define a passageway through which the card is able to travel. These sponges may be suitably mounted onto two rollers, respectively, which rotate in opposite direction.

According to another advantageous feature of the present invention, a dryer may be disposed between the disinfector and the exit slot for drying disinfectant applied on the card. The dryer may advantageously include two hot-air blowers.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic side section of a first embodiment of a reading unit according to the present invention, including UV irradiation as disinfector;

FIG. 2 is a schematic side section of a second embodiment of a reading unit according to the present invention, using a disinfectant; and

FIG. 3 is a schematic side section of a third embodiment of a reading unit according to the present invention, including UV irradiation and a disinfectant.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

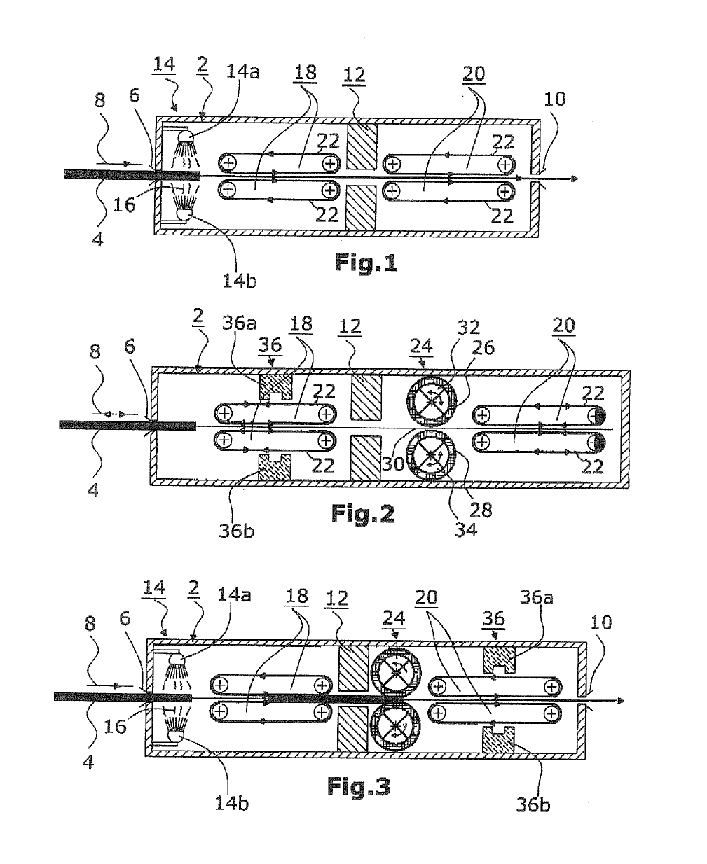

Turning now to the drawing, and in particular to FIG. 1, there is shown a schematic side section of a first embodiment of a reading unit according to the present invention, generally designated by reference numeral 2, for reading information contained on a card 4, for example made of plastic. By way of example, the reading unit 2 has a rectangular configuration. The information may be stored on the card 4, e.g., on a chip or magnetic strip. Examples of cards 4 may include credit cards, gas station cards, airline cards, or cards issued by supermarkets or department stores. Cards of this type pose a health hazard for users because of the risk of infection, e.g. when handed to other persons or inserted in a respective machine or equipment for reading purposes.

The reading unit 2 normally includes an entry device for receiving the card 4. For sake of simplicity, the entry device is shown here only by way of an entry slot 6 which leads into the interior of the housing. The direction in which the card 4 is inserted into the entry slot 6 and transported through the reading unit 2 is designated by arrow 8. A dispensing device is situated at the other end of the reading unit 2 and is shown here only by way of an exit slot 10. Located inside the reading unit 2 is a reader 12 for reading information or data stored on the card 4.

In order to disinfect the card 4 inserted through the entry slot 6, the reading unit 12 is provided interiorly with a disinfector 14. In the example of FIG. 1, the disinfector 14 is arranged in immediate proximity behind the entry slot 6 and constructed to disinfect both sides of the card 4 as the card 4 passes through. The disinfector 14 includes a light source in the form of an upper UV light tube 14a and a lower UV light tube 14b disposed in parallel relation to form a passageway there between through which the inserted card 4 travels.

The card 4 is transported in the direction towards the exit slot 20 by a first transport device 18 in an area between the entry slot 6 and the reader 12, and a second transport device 20 in an area between the reader 12 and the exit slot 10. Each of the transport device 18, 20 includes a tandem of carriers, each of which including two driving rollers, indicated schematically only, and a transport belt 22 wrapped around the driving rollers. The transport device and thus the carriers for the card 4 are designated by arrows on the four transport belts 22. The spacing between the transport belts 22 of each pair is hereby sized to fit the card 4 and to allow the card 4 to pass through. The reader 12 is thus positioned between the transport devices 18, 20. The first transport device 18 is sized to grab the card 4 after being inserted through the entry slot 6, and the second transport device 20 is sized to expel the card 4 after undergoing the reading process.

As an alternative to the afore-described UV light source, it is, of course, also conceivable to provide an infrared light source.

Referring now to FIG. 2, there is shown a schematic side section of a second embodiment of a reading unit 2 according to the present invention. Parts corresponding with those in FIG. 1 are denoted by identical reference numerals and not explained again. The description below will center on the differences between the embodiments. In this embodiment, provision is made for a single slot 6 which assumes the function of an entry slot as well as of an exit slot. The transport devices 18, 20 are therefore constructed for back and forth movement, as indicated by the double arrows on the four transport belts 22. The advance of the inserted card 4 is reversed at the other (right) end of the reading unit 2 so that the insertion direction 8 corresponds to the dispensing direction, as also indicated by the double arrow 8.

In the example of FIG. 2, the reading unit 2 has a disinfector 24 which is constructed to release a liquid disinfectant upon the inserted card 4. The disinfector 24 includes two curved sponges 26, 28 which are repeatedly moistened by a not shown storage container for the disinfectant, with each of both sponges 26, 28 sweeping the card 4 along the sides, respectively. Both sponges 26, 28 are disposed in symmetry to one another so as to define a passageway 30 there between. At operation, the card 4 is inserted and transported initially from left to right and then from right to left through the passageway 30. During its travel, the card 4 is contacted by the sponges 26, 28. The sponges 26, 28 are secured on two rollers 32, 34 which rotate in opposite direction and are disposed in parallel relation. The back and forth movement of the rollers, 32, 34 is indicated by the curved double arrows. While the card 4 returns to the slot 6, it is dried by a dryer 36 in the form of twp hot-air fans 36a, 36b disposed in opposition to one another in the area between the slot 6 and the reader 12 in proximity of the transport belts 22 near the exit of the card 4. The reader 12 is arranged in the embodiment of FIG. 2 between the first transport device 18 and the disinfector 24.

FIG. 3 is a schematic side section of a third embodiment of a reading unit according to the present invention. Parts corresponding with those in FIGS. 1 and 2 are again denoted by identical reference numerals and not explained again. In this embodiment, provision is made for two disinfectors 14, 24, which operate differently and are comprised of a UV light source 14 and a liquid disinfectant unit 24. The card 24 is inserted into entry slot 6 and is transported along a straight line through the reading unit 2 to be dispensed at the other end through the exit slot 10. The disinfector 24 is positioned between both transport devices 18, 20. The rollers 32, 34 rotate only in advance direction, as indicated by the curved arrows. The dryer 36, again comprised of hot-air fans 36a, 36b which are arranged in opposite disposition, is positioned near the dispensing device with the exit slot 10, whereas the reader 12 for the card 4 is located between the two disinfectors 14, 24.

A reading unit 2 according to the present invention is able to significantly reduce the risk of infection for the user of a card 4 as a result of the presence of one or more disinfectors 14, 24 in the reading unit 2. This is true regardless whether the potential source of infection is caused by the card 4 itself as a result of use by third parties or ultimately by the reading unit 2.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed is:

1. A reading unit, comprising:
an entry slot for receiving a card;
an exit slot for dispensing the card;
a reader arranged between the entry slot and the exit slot for reading information on the card; and
a disinfector disinfecting the card at least in one of the phases selected from the group consisting of during entry of the card into the entry slot and during discharge of the card from the exit slot.

2. The reading unit of claim 1, wherein the card is made of plastic.

3. The reading unit of claim 1, wherein the card is a credit card.

4. The reading unit of claim 1, wherein the card is a card issued by an airline.

5. The reading unit of claim 1, wherein the disinfector is arranged downstream of and in close proximity to the entry slot, as viewed in a movement direction of the card.

6. The reading unit of claim 1, wherein the disinfector includes a light source for radiating UV light or infrared light into a direction of the card.

7. The reading unit of claim 6, wherein the disinfector includes two UV light tubes arranged in parallel relation downstream of the entry slot to define a passageway through which the card is able to travel.

8. The reading unit of claim 1, wherein the disinfector is constructed to release a disinfectant onto the card.

9. The reading unit of claim 8, wherein the disinfector includes a storage container and a sponge operably connected with the storage container for repeatedly moisturizing the sponge with disinfectant.

10. The reading unit of claim 8, wherein the disinfector includes two sponges in parallel relation to define a passageway through which the card is able to travel.

11. The reading unit of claim 10, wherein the disinfector includes two rollers rotating in opposite direction, said sponges being mounted onto the rollers in one-to-one correspondence.

12. The reading unit of claim 8, further comprising a dryer disposed between the disinfector and the exit slot for drying disinfectant applied on the card.

13. The reading unit of claim 12, wherein the dryer includes two hot-air blowers.

14. The reading unit of claim 1, further comprising two of said disinfector.

15. The reading unit of claim 14, wherein the reader is disposed between the two disinfectors.

16. The reading unit of claim 1, further comprising two transport units spaced from one another sufficient to transport the card from the entry slot to the exit slot.
